(19) United States
(12) Patent Application Publication
(10) Pub. No.: US 2020/0311226 A1
(43) Pub. Date: Oct. 1, 2020

(54) METHODS, SYSTEMS, APPARATUSES AND DEVICES FOR FACILITATING SECURE PUBLISHING OF A DIGITAL CONTENT

(71) Applicant: Mohammed Ali Othman, Doha (QA)

(72) Inventor: Mohammed Ali Othman, Doha (QA)

(21) Appl. No.: 16/366,765

(22) Filed: Mar. 27, 2019

(51) Int. Cl. G06F 21/10; G06F 21/62; H04L 29/08; H04L 29/06

(52) U.S. Cl. CPC G06F 21/10; G06F 21/62; H04L 63/20; H04L 63/101; H04L 29/0809

(57) ABSTRACT

Disclosed herein is a method of facilitating secure publishing of a digital content. Further, the method may include receiving, using a communication device, the digital content from a publisher device. Further, the method may include analyzing, using a processing device, the digital content based on a security policy to obtain a security assessment of the digital content. Further, the method may include transmitting, using the communication device, a warning data to at least one trusted user device based on the security assessment. Further, the method may include receiving, using the communication device, a feedback from the at least one trusted user device. Further, the method may include publishing, using the processing device, the digital content based on at least one of the feedback and the security assessment.

### FIELD OF THE INVENTION

Generally, the present disclosure relates to the field of data processing. More specifically, the present disclosure relates to methods, systems, apparatuses and devices for facilitating secure publishing of a digital content.

### BACKGROUND OF THE INVENTION

Nowadays most of official pages and sites on social networks or cloud may be hacked by malicious hackers and false/fake content may be published by them. This leads to major problems especially if they are official or government sites or pages. In order to tackle this problem, conventional system and method add multiple security layers in order to determine if a publisher is an authorized user or not. However, no conventional techniques provide security layers to determine the authenticity of a content that may need to be published regardless of the user who wants to publish the content.

Therefore, there is a need for improved methods, systems, apparatuses and devices for facilitating secure publishing of digital content that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating secure publishing of a digital content. Further, the method may include receiving, using a communication device, the digital content from a publisher device. Further, the method may include analyzing, using a processing device, the digital content based on a security policy to obtain a security assessment of the digital content. Further, the method may include transmitting, using the communication device, a warning data to at least one trusted user device based on the security assessment. Further, the method may include receiving, using the communication device, a feedback from the at least one trusted user device. Further, the method may include publishing, using the processing device, the digital content based on at least one of the feedback and the security assessment.

Further disclosed herein is a system of facilitating secure publishing of a digital content. Further, the system may include a communication device configured for receiving the digital content from a publisher device. Further, the communication device may be configured for transmitting a warning data to at least one trusted user device based on a security assessment. Further, the communication device may be configured for receiving a feedback from the at least one trusted user device. Further, the system may include a processing device configured for analyzing the digital content based on a security policy to obtain the security assessment of the digital content. Further, the processing device may be configured for publishing the digital content based on at least one of the feedback and the security assessment.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system of facilitating secure publishing of a digital content, in accordance with some embodiments.

FIG. 3 is a flowchart of a method of facilitating secure publishing of a digital content, in accordance with some embodiments.

FIG. 4 is a flowchart of a method to facilitate storing security policy, in accordance with further embodiments.

FIG. 5 is a flowchart of a method to facilitate analyzing the digital content based on the security policy to obtain the security assessment of the digital content, in accordance with further embodiments.

FIG. 6 is a flowchart of a method to facilitate subscribing Critical Content Security Layer (CCSL) service on a website for a user, in accordance with some embodiments.

FIG. 7 is a flowchart of a method to facilitate critical patterns (and/or critical content) detection process, in accordance with some embodiments.

FIG. 8 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of secure publishing of digital content, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure includes a method and a system to facilitate secure publishing of a digital content. Further, the method for ensuring that no critical content may be published until a checking process and/or a validating process may be done based on comparing specific predefined patterns.

Further, the system, in an instance, may be added to any social network platform and/or considered as an optional (and additional security layer), so all customers and accounts may add this layer and pay annual fees. Further, once the customer may be subscribed to the additional security layer service, the system may ask the user to do some configuration and add some information. Further, the information may be used as a pattern and may train the system. Further, the system may use the information (such as the patterns) in validation steps, so later on and while a certain content is being published to the pages by the authorized person or the person who know the user name and password and can access the pages. The system may make a comparison and validate using the predefined patterns and keywords, so if the system detects some critical content, based on the recognition of the predefined critical patterns and keyword, the system may hold the content and/or may send alerts and warning messages to the owner and the responsible and trusted persons. Further, the owner and the responsible and trusted persons may release or prevent the content from publishing.

Further, in some embodiments, a security layer may be implemented based on pattern recognition techniques and artificial intelligence. Further, the security layer may be considered as a layer that may be added and/or may be configured to subscribed pages. Further, clients may be asked to do some configuration and program learning. For instance, by entering some critical keywords that should consider the content as “Critical Content.” So once the security layer may be added to a page/account, the content that may be published later on, in an instance, may be controlled and/or obeyed to some validation steps. Further, the validation and recognition steps may be done as a core of the security layer. Further, in case of the content considered as critical content the system may make holding of publishing regardless if the publisher may be an authorized person or a hacker.

Further, if the content considered as a critical content, a notification may be sent to one or more trusted owners in order to let them (trusted owners) know the content. Further, information such as a publisher's IP address, time of publishing, location/country, browser, and the detected patterns may also be shared. Further, the system may ask the trusted owner to respond to the system by “allow” or “don't allow”, then the system according to the respond of the trusted owner may publish the content and/or keep the content holding and added to the holding pool on the system that may be reviewed by the trusted owners, and take further security actions.

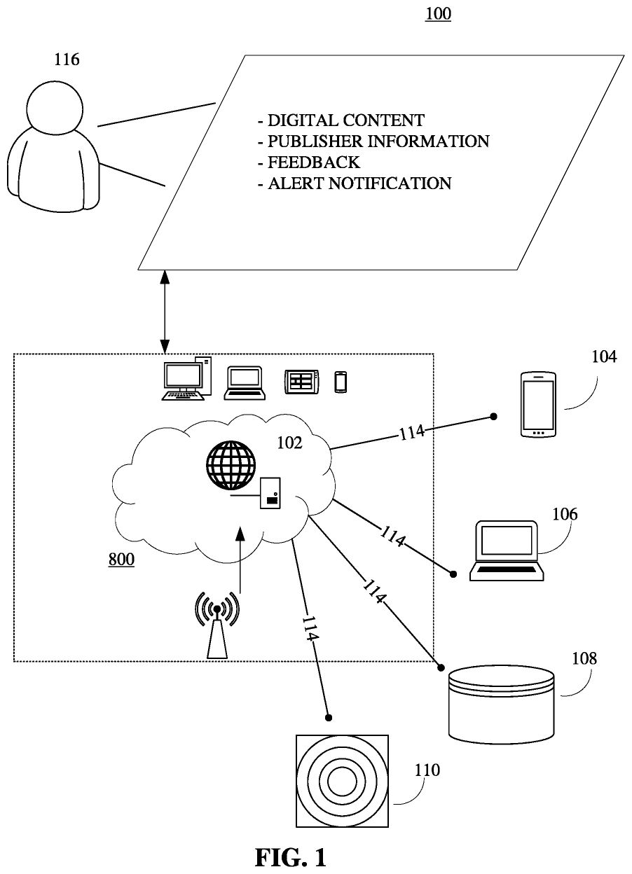

FIG. 1 is an illustration of an online platform 100 consistent with various embodiments of the present disclosure. By way of non-limiting example, the online platform 100 to facilitate secure publishing of digital content may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 800.

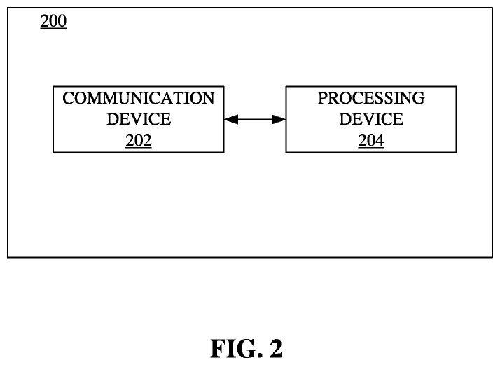

FIG. 2 is a block diagram representation of a system 200 of facilitating secure publishing of a digital content, in accordance with some embodiments. Further, the system 200 may include a communication device 202 configured for receiving the digital content from a publisher device. Further, the digital content, in an instance, may be any content in a digital form that the user may wish to publish on a one or more of platforms (such as, but not limited to, social media platforms, forums etc.). Further, the digital content may include, but is not limited to, one or more of audio content, video content, textual content, multimedia content and sensor data. Further, the digital content may be captured by one or more sensor devices such as, but not limited to, a camera, a microphone and one or more sensors configured to capture physical, chemical and/or biological variables. Further, the digital content may be stored in one or more storage devices such as but not limited to, semiconductor memory, magnetic storage etc. Further, the one or more sensor devices and the one or more storage devices, in an instance, may be embedded within the publisher device. Further, the publisher device, in an instance, may be any user device that may allow a user (such as a publisher) to publish the digital content. Further, the publisher device, in an instance, may be an IoT based device that may be configured to communicate with the online platform 100. For instance, the publisher device may include, but not limited to, a smartphone, a smartwatch, a laptop, a PC etc.

Further, the communication device 202 may be configured for transmitting a warning data to at least one trusted user device based on a security assessment. Further, in some embodiments, the at least one trusted user device, in an instance, may be an IoT based device which may be operated by a trusted user. Further, the trusted user, in an instance, may be an individual (such as an owner of a social media account), who may be authorized to review, for e.g. in order to approve and/or disapprove, the digital content before publishing the digital content on the at least one or more platforms. Further, in some embodiments, the warning data may include at least one of the digital content and a publisher information. Further, the publisher information may include at least one of a publisher's Internet Protocol (IP) address, a publisher's browser, a time of publishing, and a publisher's location. Further, the security assessment, in an instance, may be an assessment associated with the digital content performed by the online platform 100 in order to categorize the digital content as a secured content and/or a critical content. Further, the secured content, in an instance, may be the digital content that may be considered (as per the owner) as appropriate for publishing. Further, the critical content, in an instance, may be the digital content that may be considered (as per the owner) as inappropriate for publishing.

Further, the communication device 202 may be configured for receiving a feedback from the at least one trusted user device. Accordingly, the at least one trusted user device, in an instance, may be any user device that may be operated by a trusted user. Further, the trusted user, in an instance, may be an individual that may be authorized to provide the feedback before publishing the digital content. For instance, the trusted user may be an owner of an account on a social media website where the digital content may need to be published. Further, the feedback, in an instance, may be any reply from the trusted users with regard to the security assessment of the digital content. For instance, the feedback may include (but not limited to) an approval (that may allow the digital content to be published) and/or a disapproval (that may not allow the digital content to be published) from the trusted user for the digital content.

Further, the system 200 may include a processing device 204 configured for analyzing the digital content based on a security policy to obtain the security assessment of the digital content. Accordingly, the security policy, in an instance, may be a set of rules and/or patterns that may be used in order to obtain the security assessment of the digital content. In some embodiments, the security policy may include at least one of a plurality of keywords and a plurality of phrases. In some embodiments, the security policy may include at least one of a textual content, an image content, a video content, an audio content and a multimedia content.

Further, the processing device 204 may be configured for publishing the digital content based on at least one of the feedback and the security assessment.

In some embodiments, the communication device 202 may be further configured for receiving the security policy from an administrator device. Further, the administrator device, in an instance, may be any device that may be operated by an administrator (and/or an individual authorized to provide the security policy) such as an owner of a page/account (such as a social media account). Further, the administrator device, in an instance, may include IoT based devices such as (but not limited to) a mobile device 104 (such as a smartphone, a laptop, a tablet computer etc.), other electronic devices 106 (such as desktop computers, server computers etc.), and so on. Further, the system 200 may include a storage device configured for storing the security policy.

In some embodiments, the processing device 204 may be further configured for processing the digital content. Further, the processing device 204 may be configured for generating metadata corresponding to the digital content based on the processing. Further, the processing device 204 may be configured for comparing the metadata corresponding to the digital content with the security policy to obtain the security assessment.

In some embodiments, the feedback may include a user response from the user of the trusted user device. Further, in some embodiments, the user response may be available in at least one of a textual form, an audio form, a visual form, an audiovisual form, and so on. Further, the user response may include at least one of an acceptance and a rejection. In some embodiments, the processing device 204 may be configured to update the security policy if the user response may be the acceptance. Further, in some embodiments, the processing device 204 may be configured to trigger a security action if the user response may be the rejection. Further, in some embodiments, the security action may include transmitting (using the communication device 202) an alert notification to the at least one trusted user device. Further, the alert notification may include (but not limited to) at least one of an email, an SMS, a voice call, a voicemail, an audio alert etc. Further, in some embodiments, the security action may include at least one of preventing the digital content from publishing, changing of account credentials, and account holding. For instance, if the user response is the rejection, then the online platform 100 may trigger the security action, for e.g., by changing account credentials (such as username and/or password associated with an account) in order to prevent any potential inappropriate access of the account by a hacker. Further, the online platform 100, in an instance, may share new account credentials with the trusted user (and/or owner of the account) through the trusted user device. Further, in another instance, the online platform 100 may trigger the security action, such as account holding, in order to prevent the publishing of the digital content. For example, if the user response is the rejection, then the online platform 100 may seize an account and/or may not allow the user to publish any content.

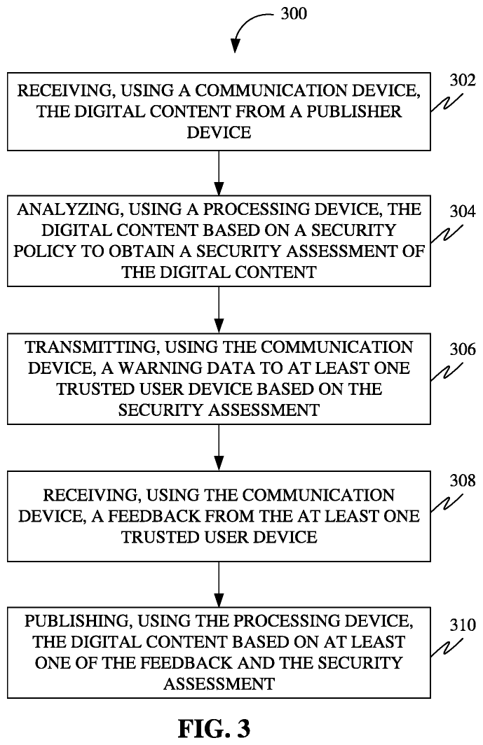

FIG. 3 is a flowchart of a method 300 of facilitating secure publishing of a digital content, in accordance with some embodiments. Further, at 302, the method 300 may include receiving, using a communication device (such as the communication device 202), the digital content from a publisher device.

Further, at 304, the method 300 may include analyzing, using a processing device (using the processing device 204), the digital content based on a security policy to obtain a security assessment of the digital content. Further, in some embodiments, the security policy may include at least one of a plurality of keywords and a plurality of phrases. In some embodiments, the security policy may include at least one of textual content, an image content, a video content, an audio content and a multimedia content.

Further, at 306, the method 300 may include transmitting, using the communication device, a warning data to at least one trusted user device based on the security assessment. In some embodiments, the warning data may include at least one of the digital content and a publisher information. Further, the publisher information may include at least one of a publisher's Internet Protocol (IP) address, a publisher's browser, a time of publishing, and a publisher's location.

Further, at 308, the method 300 may include receiving, using the communication device, a feedback from the at least one trusted user device. In some embodiments, the feedback may include a user response. Further, in some embodiments, the user response may be in at least one of a textual form, an audio form, a visual form, an audiovisual form, and so on. Further, the user response may include at least one of an acceptance and a rejection. In some embodiments, the processing device may be configured to update the security policy if the user response may be the acceptance. Further, in some embodiments, the processing device may be configured to trigger a security action if the user response may be the rejection. Further, in some embodiments, the security action may include transmitting an alert notification to the at least one trusted user device. Further, the alert notification may include (but not limited to) at least one of an email, an SMS, a voice call, a voicemail, an audio alert and so on. In some embodiments, the security action may include at least one of preventing the digital content from publishing, changing of account credentials, and account holding.

Further, at 310, the method 300 may include publishing, using the processing device, the digital content based on at least one of the feedback and the security assessment.

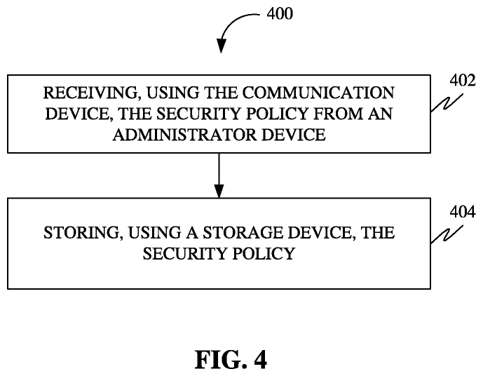

FIG. 4 is a flowchart of a method 400 to facilitate storing security policy, in accordance with further embodiments. Accordingly, at 402, the method 400 may include receiving, using the communication device, the security policy from an administrator device. Further, the administrator device, in an instance, may be any device that may be operated by an administrator (and/or an individual authorized to provide the security policy) such as an owner of a page/account (such as a social media account). Further, the administrator device, in an instance, may include IoT based devices such as (but not limited to) a mobile device 104 (such as a smartphone, a laptop, a tablet computer etc.), other electronic devices 106 (such as desktop computers, server computers etc.), and so on. Further, at 404, the method 400 may include storing, using a storage device, the security policy. In some embodiments, the security policy, in an instance, may be encrypted by using the processing device before the storing.

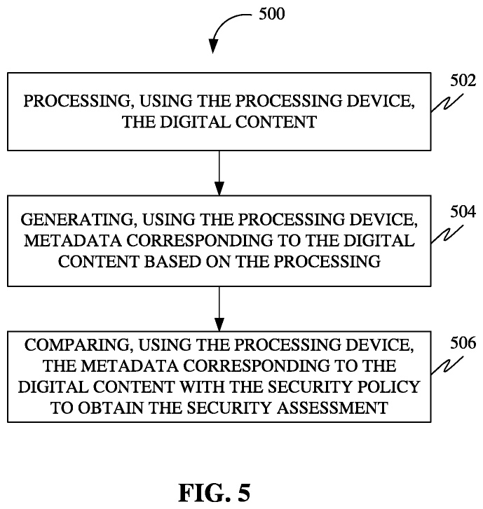

FIG. 5 is a flowchart of a method 500 to facilitate analyzing the digital content based on the security policy to obtain the security assessment of the digital content, in accordance with further embodiments. Accordingly, at 502, the method 500 may include processing, using the processing device, the digital content.

Further, at 504, the method 500 may include generating, using the processing device, metadata corresponding to the digital content based on the processing.

Further, at 506, the method 500 may include comparing, using the processing device, the metadata corresponding to the digital content with the security policy to obtain the security assessment.

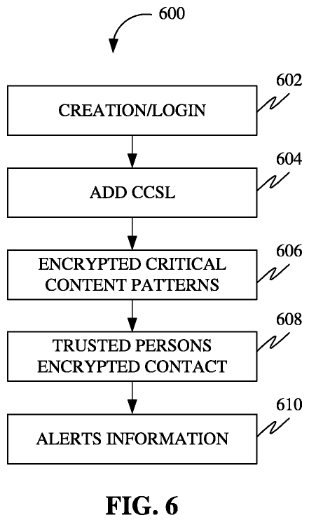

FIG. 6 is a flowchart of a method 600 to facilitate subscribing Critical Content Security Layer (CCSL) service on a website for a user, in accordance with some embodiments. Accordingly, at 602, the method 600 may include creating an account and/or a page associated with the website. Further, the website, in an instance, may be any webpage on which the user may wish to add an additional layer of security. For instance, the website may include (but not limited to) a social media website (e.g. Facebook, Twitter, Instagram, Snapchat etc.) on which the user may wish to add another security layer (such as the CCSL) that may facilitate secure publishing of the digital content. Further, the online platform 100, in an instance, may be configured to provide a user interface that may include an optional “Add CCSL button” on the webpage. Further, at 604, the method 600 may include a step of adding the CCSL service on the website. For instance, the user may select (e.g. by clicking on the “Add CCSL button” through a user device such as a laptop), which may allow the user to add the CCSL service. Further, once the CCSL service may be added, the user may define keywords, sentences, images, and/or videos etc. that may be a part of a critical content. Further, the critical content, in an instance, may be any content that the user may not wish to publish on the website. Further, in some embodiments, the critical content, in an instance, may be any content that may require additional approval before publishing on the website. For instance, for one user, the critical content may include offensive texts, violent videos, hate speeches etc. Further, at 606, the method 600 may include a step of encrypting critical content patterns. Further, the online platform 100, in an instance, may be configured to encrypt the critical content patterns to protect the critical words (such as the keywords) and patterns that may enhance security. Further, at 608, the method 600 may include a step of adding a contact associated with a trusted person (trusted person encrypted contact). Further, the contact associated with the trusted person, in an instance, may be encrypted by the online platform 100. Further, the contact, in an instance, may be any information that may allow the online platform 100 to communicate with the trusted person (through the trusted user device). Further, the trusted person, in an instance, may be individual that may be authorized to provide an approval for the digital content before publishing the digital content. Further, at 610, the method 600 may include a step of adding an alert information. For instance, the user may choose alert and holding processes, actions, and/or may define communication ways, content release and approval processes etc.

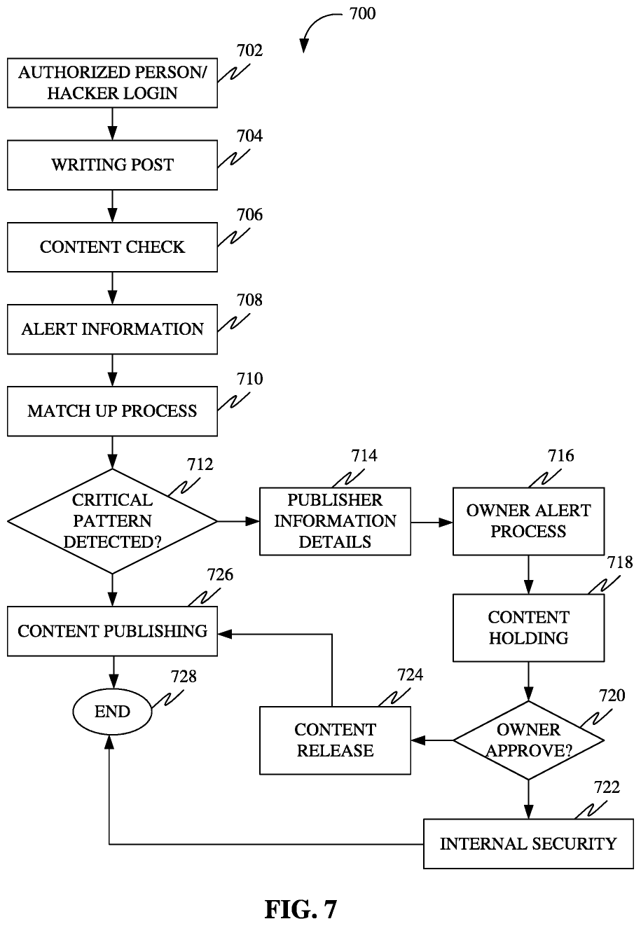

FIG. 7 is a flowchart of a method 700 to facilitate critical patterns (and/or critical content) detection process, in accordance with some embodiments. Accordingly, at 702, the method 700 may include a step of login by either a trusted person (an authorized user) or a hacker (an unauthorized user). Further, after login to a page/account by a user (e.g. either by the trusted person or the hacker), the user may provide digital content in order to publish the digital content. For instance, at 704, the user may provide a digital content (such as by writing a post) to publish the digital content. Further, at 706 during a posting process, the method 700 may include a step of checking the digital content. Further, at 708, the method 700 may include a step of adding alert information. Further, at 710, the method 700 may include a match up process. Further, the online platform 100, in an instance, may perform content match up/comparison process using the predefined patterns, and then according to the results of the match up process the online platform 100 may perform further steps. For instance, notifications and alerts may be sent to a user device associated with the trusted person (and/or owner). Further, the notifications and alerts may include the digital content (e.g. text/photos) and/or may ask the owner to react by providing a reply (e.g. a yes/no reply) through the user device (such as a smartphone). Further, at 712, the online platform 100 may determine if a critical pattern may be detected. For instance, if no critical pattern may be detected, at 726, the online platform may publish the content and/or the method 700 may end (as shown at 728). Further, in another instance, if a critical pattern may be detected, the online platform 100 may share publisher information details (as shown at 714), initiate owner alert process (as shown at 716), hold the digital content (as shown at 718), and/or may ask the owner to approve (as shown at 720) the digital content. For instance, at 724, if the digital content may be approved by the owner, the online platform 100 may release the digital content for publishing. Further, at 722, if the digital content may not be approved by the owner, the online platform 100 may inform internal security. Further, in some embodiments, In case of content detected and considered as critical and later approved by the owner (such as responded as trusted by the owner), then the online platform 100 may update patterns pool and log. For instance, the online platform 100 may add some information to a knowledge-base (such as databases 108) of the system.

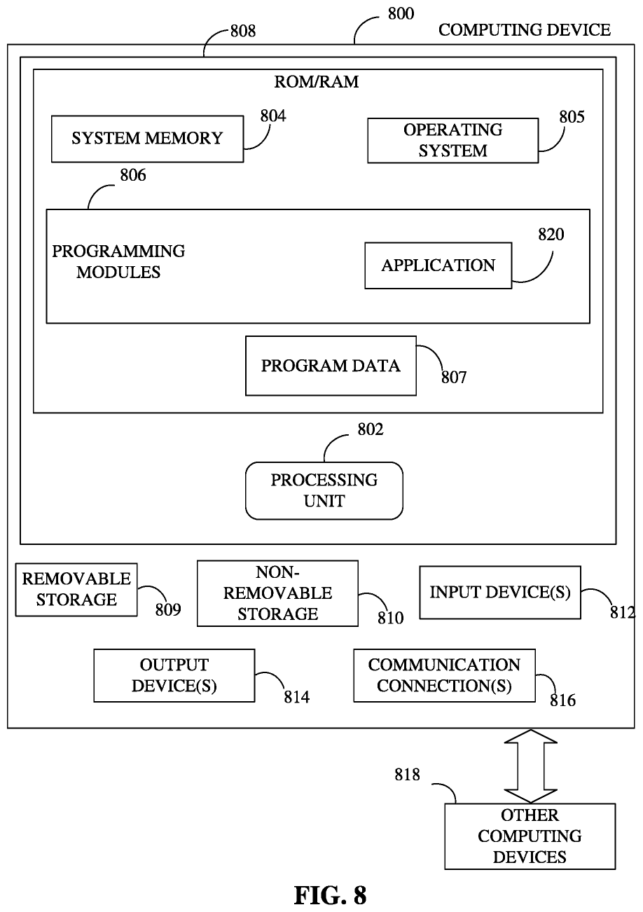

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and non-volatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820 such as a media player) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating secure publishing of a digital content, the method comprising:
receiving, using a communication device, the digital content from a publisher device;
analyzing, using a processing device, the digital content based on a security policy to obtain a security assessment of the digital content;
transmitting, using the communication device, a warning data to at least one trusted user device based on the security assessment;
receiving, using the communication device, a feedback from the at least one trusted user device; and
publishing, using the processing device, the digital content based on at least one of the feedback and the security assessment.

2. The method of claim 1, wherein the security policy comprises at least one of a plurality of keywords and a plurality of phrases.

3. The method of claim 1, wherein the security policy comprises at least one of a textual content, an image content, a video content, an audio content and a multimedia content.

4. The method of claim 1, wherein the method further comprising:
receiving, using the communication device, the security policy from an administrator device; and
storing, using a storage device, the security policy;

5. The method of claim 1, wherein the analyzing further comprising:
processing, using the processing device, the digital content;
generating, using the processing device, metadata corresponding to the digital content based on the processing; and
comparing, using the processing device, the metadata corresponding to the digital content with the security policy to obtain the security assessment.

6. The method of claim 1, wherein the warning data comprises at least one of the digital content and a publisher information, wherein the publisher information comprises at least one of a publisher's Internet Protocol (IP) address, a publisher's browser, a time of publishing, and a publisher's location.

7. The method of claim 1, wherein the feedback comprises a user response from the user of the trusted user device, wherein the user response comprises at least one of an acceptance and a rejection.

8. The method of claim 7, wherein the processing device is configured to update the security policy if the user response is the acceptance.

9. The method of claim 7, wherein the processing device is configured to trigger a security action if the user response is the rejection.

10. The method of claim 9, wherein the security action comprises at least one of preventing the digital content from publishing, changing of account credentials, and account holding.

11. A system of facilitating secure publishing of a digital content comprising:
a communication device configured for:
receiving a digital content from a publisher device;
transmitting a warning data to at least one trusted user device based on a security assessment; and
receiving a feedback from the at least one trusted user device;
a processing device configured for:
analyzing the digital content based on a security policy to obtain the security assessment of the digital content; and
publishing the digital content based on at least one of the feedback and the security assessment.

12. The system of claim 11, wherein the security policy comprises at least one of a plurality of keywords and a plurality of phrases.

13. The system of claim 11, wherein the security policy comprises at least one of a textual content, an image content, a video content, an audio content and a multimedia content.

14. The system of claim 11, wherein the communication device is further configured for receiving the security policy from an administrator device; wherein the system further comprising a storage device configured for storing the security policy;

15. The system of claim 11, wherein the processing device is further configured for:
processing the digital content;
generating metadata corresponding to the digital content based on the processing; and
comparing the metadata corresponding to the digital content with the security policy to obtain the security assessment.

16. The system of claim 11, wherein the warning data comprises at least one of the digital content and a publisher information, wherein the publisher information comprises at least one of a publisher's Internet Protocol (IP) address, a publisher's browser, a time of publishing, and a publisher's location.

17. The method of claim 11, wherein the feedback comprises a user response from the user of the trusted user device, wherein the user response comprises at least one of an acceptance and a rejection.

18. The method of claim 17, wherein the processing device is configured to update the security policy if the user response is the acceptance.

19. The method of claim 17, wherein the processing device is configured to trigger a security action if the user response is the rejection.

20. The method of claim 19, wherein the security action comprises at least one of preventing the digital content from publishing, changing of account credentials, and account holding.
